(19) United States
(12) Patent Application Publication
(10) Pub. No.: US 2012/0222512 A1
(43) Pub. Date: Sep. 6, 2012

(54) DOUBLE CLUTCH ACTUATION ARRANGEMENT

(75) Inventors: Nicolas RENARD, Karlsruhe (DE); Pierre STENGEL, Wolxheim (DE); Nicolas FUNALOT, Souffel Weyersheim (FR); Vincent GAUTIER, Westhouse (FR)

(73) Assignee: GM GLOBAL TECHNOLOGY OPERATIONS, INC., Detroit, MI (US)

(21) Appl. No.: 12/916,392

(22) Filed: Oct. 29, 2010

(30) Foreign Application Priority Data
Nov. 3, 2009 (GB) 0919246.9

(51) Int. Cl. F16H 3/08; F16D 21/00

(52) U.S. Cl. 74/331; 192/48.1

(57) ABSTRACT

A double clutch assembly is provided in accordance with an embodiment. A pivot axis of a first lever and a pivot axis of a second lever is located at the same side of a first actuating element and of a second actuating element, namely at the same side of the tubular element and of the annular element. Furthermore, the first lever is provided with a first lever actuation area in form of the toe end area of the inner lever for a first actuator device, for example a piston. The first actuating element in form of the tubular element is situated in an area between the first lever actuation area and the pivot axis of the first lever.

### CROSS-REFERENCE TO RELATED APPLICATION

This application claims priority to British Patent Application No. 0919246.9, filed Nov. 3, 2009, which is incorporated herein by reference in its entirety.

### TECHNICAL FIELD

The technical field relates to a clutch actuation arrangement, and more particularly to a double clutch actuation arrangement.

### BACKGROUND

A double clutch transmission of a vehicle generally has a first clutch actuator for actuating a first clutch and a second clutch actuator for actuating a second clutch. The clutch actuators act on their respective clutch release bearings. A conventional double clutch transmission provides two input shafts that can be connected to the motor of a vehicle by corresponding clutches.

For double clutch transmissions, dry or wet clutches are used. In dry clutches, the generated heat is dissipated via steal masses whereas in wet clutches a special cooling medium is employed.

To actuate the double clutch, the respective coupling actuators must act on the respective coaxial clutch release bearings. The design of the coupling arrangement must furthermore satisfy spatial constraints such as the limitation to fit into the space between motor and gearbox.

### SUMMARY

A double clutch actuation arrangement is provided that includes, but is not limited to a first lever for actuating a first actuating element for a first clutch friction element, a second lever for actuating a second actuating element for a second clutch friction element. A pivot axis of the first lever and a pivot axis of the second lever are located at the same side of the first actuating element and the second actuating element, and in that the first lever is provided with a first lever actuation area for a first actuator device. The first actuating element being situated in an area between the first lever actuation area and the pivot axis of the first lever.

A powertrain assembly is also provided that includes, but is not limited to an engine and a gearbox with a first input shaft and a second input shaft. The powertrain assembly further includes, but is not limited to a double-clutch assembly as previous set forth in the preceding paragraph, a first clutch connecting the engine with the first input shaft and a second clutch connecting the engine with the second input shaft. The power train assembly also includes, but is not limited to a first actuator device for a first clutch, and the first actuator device includes, but is not limited to the first lever and the first clutch release bearing. The powertrain assembly further includes, but is not limited to a second actuator device for a second clutch, and the second actuator device includes, but is not limited to the second lever and the second clutch release bearing.

A vehicle is also provided with the powertrain as set forth in the preceding paragraph.

### BRIEF DESCRIPTION OF THE DRAWINGS

The present invention will hereinafter be described in conjunction with the following drawing figures, wherein like numerals denote like elements, and:

FIG. 1 illustrates a side view of a double clutch arrangement;

FIG. 2 illustrates a perspective oblique view of the double clutch arrangement of FIG. 1;

FIG. 3 illustrates a top view of the double clutch arrangement of FIG. 4; and

FIG. 4 illustrates a schematic side view of the double clutch arrangement of FIG. 1, the side view showing upper and lower lever positions.

### DETAILED DESCRIPTION

The following detailed description is merely exemplary in nature and is not intended to application and uses. Furthermore, there is no intention to be bound by any theory presented in the preceding background or summary or the following detailed description. Also, in the following description, details are provided to describe the embodiments. It shall be apparent to one skilled in the art, however, that the embodiments may be practiced without such details.

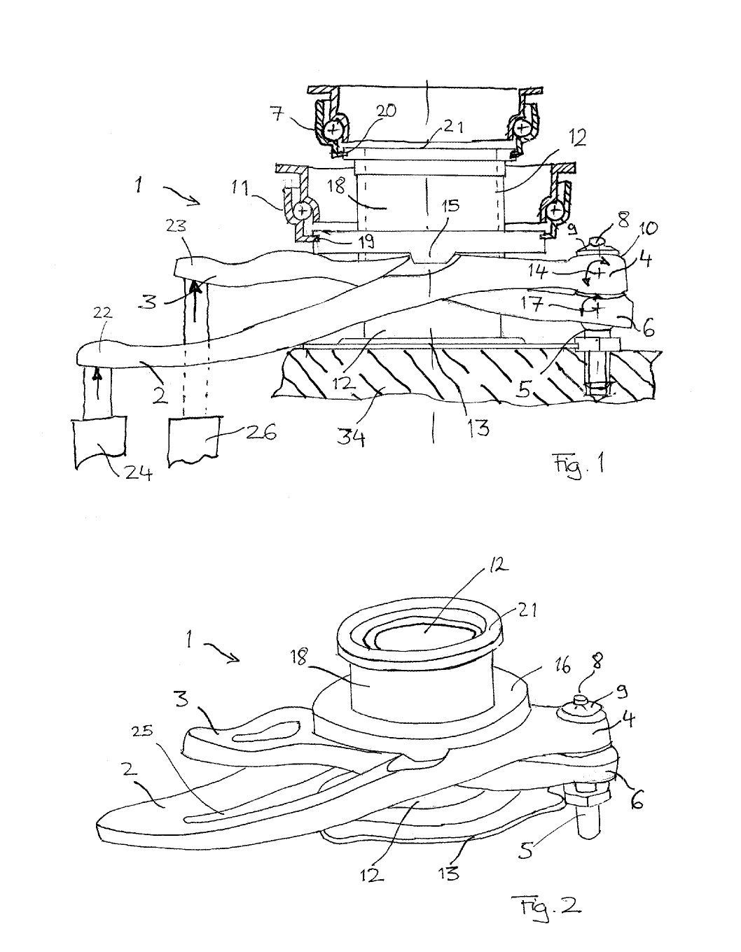

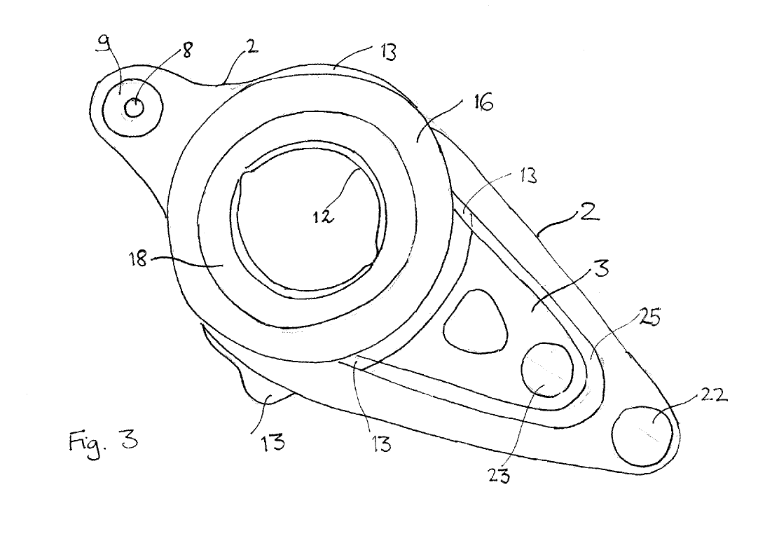

FIG. 1 shows a side view of an actuation arrangement 1 for a double clutch. The actuation arrangement 1 comprises a bigger outer lever 2 and a smaller inner lever 3. The respective shapes of the outer lever 2 and the inner lever 3 are similar to an outline of a shoe. The shapes can be best seen in the perspective view of FIG. 2. The levers 2, 3 are fixed onto a bolt 5 by a bolt head 8. A heel end 4 of the outer lever 2 is mounted onto the bolt 5 such that the outer lever 2 can pivot around an outer lever pivot axis 14 that is perpendicular to the bolt 5. The heel end 4 of the outer lever 2 further comprises a convex portion 10. A round plate 9 is provided between the bolt head 8 and the convex portion 10 such that the outer lever 2 is allowed to pivot around the outer lever pivot axis 14.

Similarly, a heel end 6 of the inner lever 3 is mounted onto the bolt 5. The heel end 6 of the inner lever 3 is mounted below the heel end 4 of the outer lever 2 such that the inner lever can pivot around an inner lever pivot axis 17 which is parallel to the outer lever pivot axis 14. The bolt 5 has a round knuckle on which the inner lever 3 can pivot. On the top of the heel end 6 of the inner lever 3 a round knuckle is provided on which the outer lever 2 can pivot. In FIG. 1, the knuckles of the bolt 5 and of the inner lever 3 are only partially visible.

An actuation joint 15 at the upper side of the outer lever 2 is connected to an annular element 16. Similarly, an actuation joint of the inner lever 3 is connected to a tubular element 18. Both of the levers 2, 3 are hollow such that a guiding tube 12 fits through hollow portions of the levers 2, 3. The tubular element 18 is arranged around the guiding tube 12 such that the tubular element can slide up and down along the axis of the guiding tube 12. A bottom plate 13 is provided at the bottom of the guiding tube 12. The bottom plate 13 is fixed to a gearbox case 34. The annular element 16 is arranged around the tubular element 18 such that the annular element can slide up and down along the axis of the tubular element 18.

Furthermore, an annular groove 19 on the outer surface of the annular element 16 is provided for taking up an outer clutch release bearing 11. Similarly, an annular groove 20 at the outer surface of a top section 21 of the tubular element 18 is provided for taking up an inner clutch release bearing 7.

The guiding tube 12, the tubular element 18 and the annular element 16 are arranged concentrically around the common axis of a solid input shaft and a hollow input shaft of a gearbox, which are not shown. Furthermore, the bolt 5 is arranged parallel to the common axis of the solid input shaft and the hollow input shaft. A lower end of the bolt 5 is fastened to the gearbox case 34 by means of a threaded screw connection.

The toe ends of the levers 2, 3 have a concave form 22, 23 on their bottom sides, respectively. Ends of pressure actuators 24, 26, as for example the ends of piston rods, are fitted into the concave forms 22, 23 to provide a pressure force from below. A first pressure plate, which is not shown, is fixed to the annular groove 20 of the top section 21 of the tubular element 18. A second pressure plate, which is not shown, is fixed to the annular groove 19 of the annular element 16.

FIG. 2 shows a perspective view of the actuation arrangement of FIG. 1. For clarity, details of FIG. 1 like the clutch release bearings 7, 11 and the gearbox case 34 are omitted in FIG. 2 and the following figures. The levers are shown in the same position as in FIG. 1. The inner lever 3 and the tubular element 18 are shown in an upper position. The outer lever 2 and the lever 2 and the annular element are shown in a lower position. FIG. 2 further shows that a major portion of the inner lever 3 which includes the toe end but excludes the heel end, is arranged within a hollow portion 25 of lever 2. A portion of the guiding tube 12 which is arranged within the tubular element 18 is shown.

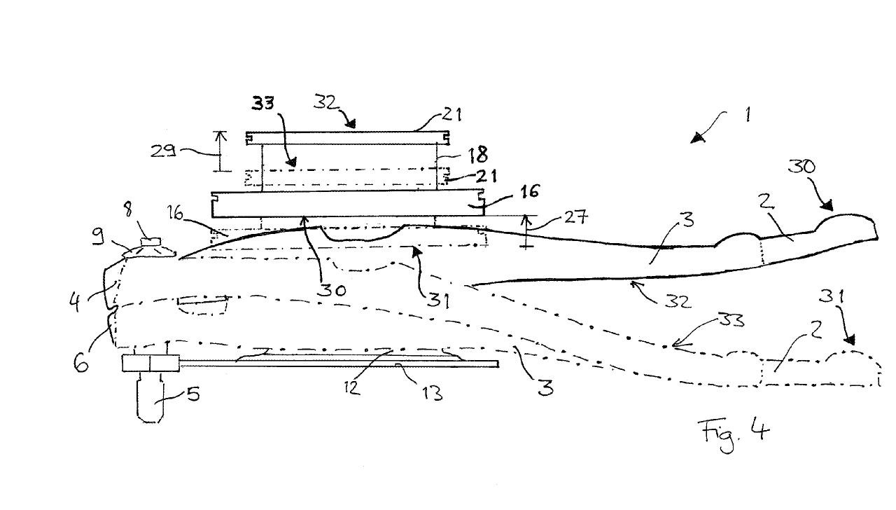

FIG. 3 shows a top view of the actuation arrangement of FIG. 1. The top view of FIG. 3 shows the form of the outline of outer lever 2 and the hollow part 25 of outer lever 2.

FIG. 4 shows a side view of the actuation arrangement of FIG. 1. In the side view, the outer lever 2 is shown in an upper position 30 and in a lower position 31. The upper position of the outer lever 2 is shown with a continuous line and the lower position of the outer lever 2 is shown with a dashed line. A corresponding upper position 30 is shown with a continuous line and a lower position 31 of the annular element 16 is shown with a dashed line. A distance 27 indicates the difference between the lower position 31 and the upper position 30 of the annular element 16.

Likewise, FIG. 4 shows an upper position 32 of the inner lever 3 and a lower position 33 of the inner lever 3. A corresponding upper position 32 of the tubular element 18 and a corresponding lower position 33 of the tubular element are also shown. A distance 29 indicates the difference between the lower position 33 and the upper position 32 of the tubular element 18. Instead of pistons pushing the levers 2, 3, clutch cables may be used to pull the levers 2, 3.

In an alternative embodiment, the tubular element 18 may glide on the inside of a guiding tube. Further alternatives are possible. For example, the annular element 16 may glide on a second guiding tube. Furthermore, the annular element 16 or the tubular element 18 may glide on the inside or on the outside of the second guiding tube. Instead of the guiding tube 12, other guiding means may be provided.

In a further embodiment only one of the levers 2, 3 pivots on a knuckle and is actuated from its toe end, while the other lever 2, 3 is actuated from its heel end. The actuation from the heel end can be provided by mounting the heel end of the lever 2, 3 on an actuation rod that is provided in direction of the pivot axis of the lever 2, 3. The lever 2, 3 can be actuated by turning the actuation rod. Instead of knuckles, rods or other means may be provided which allow the levers 2, 3 to pivot at their heel ends.

A double clutch actuation arrangement is provided in accordance with embodiments. The double clutch actuation arrangement has a first lever in form of an inner lever 3 for actuating a first actuating element in form of the tubular element 18 which actuates the inner clutch release bearing 7. Furthermore, a second lever is provided in form of the outer lever 2 for actuating a second actuating element in form of the annular element 16 which actuates the outer clutch release bearing 11.

A pivot axis of the first lever and a pivot axis of the second lever is located at the same side of the first actuating element and of the second actuating element, namely at the same side of the tubular element 18 and of the annular element 16. Furthermore, the first lever is provided with a first lever actuation area in form of the toe end area of the inner lever 3 for a first actuator device, for example a piston. The first actuating element in form of the tubular element 18 is situated in an area between the first lever actuation area and the pivot axis of the first lever.

The second actuating element in form of the annular element 16 is situated in an area between the second lever actuation area and the pivot axis of the second lever. The second lever is provided with a second lever actuation area for a second actuator device in form of an outer lever toe end.

A double clutch assembly is also provided that comprises the above-mentioned double clutch actuation arrangement. Clutch release bearings 7, 11 are shown in FIG. 1. Other parts of the double clutch assembly like pressure plates are omitted for clarity. Moreover, a powertrain is provided that comprises a clutch assembly according to the application and a vehicle which comprises a powertrain according to the application.

The functioning of the double clutch actuation arrangement 1 will be explained with reference to FIG. 4. To engage an input shaft to the hollow input shaft, the concave form 23 of the inner lever 3 is pushed upwards by a piston. The inner lever 3 pivots on the knuckle of the bolt 5 and moves upwards against the tubular element 18. As the piston moves upwards, the inner lever 3 moves from its lower position 33 to its upper position 32. Thereby, the inner lever 3 pushes the tubular element 18 from its lower position 33 to its upper position 32. The tubular element 18 slides on the guiding tube 12 from its lower position 33 to its upper position 32. A center portion of a first pressure plate which is fixed to the annular grove 20 of the tubular element 18 is moved inwards and the first pressure plate is bent. The spring force of the bent first pressure plate engages a clutch of the hollow input shaft.

To disengage an input shaft from the hollow input shaft, a pressure force of the piston to the concave from 23 of the inner lever 3 is lowered. A spring force of the first pressure plate presses down the tubular element 18 and the tubular element 18 slides on the guiding tube 12 from its upper position 32 to its lower position 33. Thereby, the inner lever 3 is pushed back from its upper position 32 to its lower position 33.

To engage an input shaft to the solid input shaft, the concave form 22 of the outer lever 2 is pushed upwards by a second piston. The inner lever 2 pivots on the knuckle of the bolt 5 and moves upwards against the annular element 16. As the second piston moves upwards, the outer lever 2 moves from its lower position 31 to its upper position 30. Thereby, the outer lever 2 pushes the annular element 16 from its lower position 31 to its upper position 30. The annular element 16 slides on the tubular part from its lower position 31 to its upper position 30, a centre portion of a second pressure plate which is fixed to the annular grove 19 of the annular element 16 is moved inwards and the second pressure plate is bent. The spring force of the bent second pressure plate engages a clutch of the solid input shaft.

To disengage an input shaft from the solid input shaft, a pressure force of the second piston to the concave from 22 of the outer lever 2 is lowered. A spring force of the second pressure plate presses down the annular element 16 and the annular element 16 slides down on the tubular element 18 from its upper position 30 to its lower position 31. Thereby, the outer lever 2 is pushed back from its upper position 30 to its lower position 31.

The arrangement of an inner lever within an outer lever makes efficient use of the limited space between a motor and a gearbox. The length of the lever arms of the levers 2, 3 can be designed to provide a desired amplification of an input force.

The lever arms 2, 3 move in approximately the same direction as the annular element 16 and the tubular element 18, respectively. In turn, the annular element 16 and the tubular element 18 move parallel to the hollow input shaft and the solid input shaft of the dual clutch. Therefore, the construction can be made more stable and/or more efficient as compared to a construction in which the motion of mechanical parts changes direction.

The actuation arrangement according to the application needs only one part, a lever, to transfer the input force of a piston or a clutch cable to a motion parallel to a shaft. Therefore, the construction can be made more compact, more efficient and more stable than a construction with multiple parts.

Although the above description contains much specificity, these should not be construed as limiting the scope of the embodiments but merely providing illustration of the foreseeable embodiments. Especially the above stated advantages of the embodiments should not be construed as limiting the scope of the embodiments but merely to explain possible achievements if the described embodiments are put into practice. In addition, while at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A double clutch actuation arrangement, comprising:
a first lever adapted to actuate a first actuating element for a first clutch friction element;
a second lever adapted to actuate a second actuating element for a second clutch friction element;
a first pivot axis of the first lever and a second pivot axis of the second located at the same side of the first actuating element and the second actuating element; and
a first lever actuation area of the first lever for a first actuator device, the first actuating element situated in an area between the first lever actuation area and the first pivot axis of the first lever.

2. The double clutch actuation arrangement according to claim 1, further comprising a second lever actuation area of the second lever for a second actuator device situated in a second area between the second lever actuation area and the second pivot axis of the second lever.

3. The double clutch actuation arrangement according to claim 1, wherein the first lever is at least partly situated within the second lever.

4. The double clutch actuation arrangement according to claim 1, wherein the second lever is at least partly situated within the first lever.

5. The double clutch actuation arrangement according to claim 1, wherein the first actuating element is a tubular element adapted to slide on a guiding tube.

6. The double clutch actuation arrangement according to claim 5, wherein the second actuating element is an annular element adapted to slide on the tubular element.

7. The double clutch actuation arrangement according to claim 1, a first heel end of the first lever and a second heel end of the second lever are arranged on knuckles.

8. The double clutch actuation arrangement according to claim 1, wherein a second clutch release bearing is connected to the second lever and a first clutch release bearing is connected to the first lever.

9. A powertrain assembly comprising:
an engine;
a gearbox with a first input shaft and a second input shaft;
a double-clutch assembly, comprising:
a first lever adapted to actuate a first actuating element for a first clutch friction element;
a second lever adapted to actuate a second actuating element for a second clutch friction element;
a first pivot axis of the first lever and a second pivot axis of the second located at the same side of the first actuating element and the second actuating element; and
a first lever actuation area of the first lever for a first actuator device, the first actuating element situated in an area between the first lever actuation area and the first pivot axis of the first lever;
a first clutch connecting the engine with the first input shaft;
a second clutch connecting the engine with the second input shaft; and
a second actuator device is adapted for the second clutch, the second actuator device comprising the second lever and a second clutch release bearing,
wherein the first actuator device is adapted for the first clutch, the first actuator device comprising the first lever and a first clutch release bearing; and

10. The powertrain assembly according to claim 9, wherein the first actuating element, the second actuating element and a guiding tube are arranged concentrically around a symmetry axis of an input shaft of a gear box.

11. The powertrain assembly according to claim 9, wherein the first lever and the second lever are connected to actuators of a hydraulic actuation device.

12. The powertrain assembly according to claim 11, wherein the first lever actuation area and a second lever actuation area are mechanically connected to pistons of the hydraulic actuation device.

13. The powertrain assembly according to claim 9, wherein the first lever and the second lever are connected to clutch cables.

14. The powertrain assembly according to claim 10, wherein the guiding tube is fixed to a gearbox case of the gearbox.

15. The powertrain assembly according to claim 9, further comprising:
a solid input shaft of the gearbox mechanically connected to the first lever via a clutch release bearing; and
a hollow input shaft of the gearbox mechanically connected to the second lever via the clutch release bearing.

16. The powertrain assembly according to claim 9, wherein the first lever is at least partly situated within the second lever.

17. The powertrain assembly according to claim 9, wherein the second lever is at least partly situated within the first lever.

18. The powertrain assembly according to claim 9, wherein the first actuating element is a tubular element adapted to slide on a guiding tube.

19. The powertrain assembly according to claim 18, wherein the second actuating element is an annular element adapted to slide on the tubular element.

20. The powertrain assembly according to claim 9, a first heel end of the first lever and a second heel end of the second lever are arranged on knuckles.
